(19) United States
(12) Patent Application Publication
(10) Pub. No.: US 2020/0338737 A1
(43) Pub. Date: Oct. 29, 2020

(54) ROBOT TEACHING DEVICE

(71) Applicant: Fanuc Corporation, Minamitsuru-gun (JP)

(72) Inventor: Tomoki Katou, Minamitsuru-gun (JP)

(73) Assignee: Fanuc Corporation, Minamitsuru-gun (JP)

(21) Appl. No.: 16/839,309

(22) Filed: Apr. 3, 2020

(30) Foreign Application Priority Data
Apr. 26, 2019 (JP) 2019-086678

(51) Int. Cl. B25J 9/16; B25J 11/00; B25J 9/00

(52) U.S. Cl. CPC B25J 9/1679; B25J 9/0081; B25J 9/161; B25J 11/0005

(57) ABSTRACT

A robot teaching device includes a display device, a microphone, a voice recognition section configured to perform voice recognition processing on a voice signal and output character information representative of the voice, a correspondence storage configured to store information associating each of a plurality of types of operating screens with a recognition target word according to robot teaching, a recognition target word extracting section configured to extract, from the information stored in the correspondence storage, one or more recognition target words having a predetermined relevance to a word representative of the character information, and a screen list display unit configured to generate, on the basis of the information stored in the correspondence storage, an image showing a list of one or more operating screens corresponding to one or more recognition target words thus extracted, and display the image on the display device.

### BACKGROUND OF THE INVENTION

### 1. Field of the Invention

The present invention relates to a robot teaching device.

### 2. Description of the Related Art

Robot teaching devices configured to accept an operation through voice input have been proposed. JP 2006-68865 A describes a “programming pendant for teaching a robot, including a voice input unit 6 configured to input voice of an operator, a voice input enabling switch 7 configured to enable input of the voice input unit, a voice recognition processing unit 8 configured to recognize the voice input from the voice input unit, and a screen selecting section 9 configured to select an operating screen of the programming pendant and display the operating screen on the programming pendant on the basis of recognition results of the voice recognition processing unit 8” (Abstract).

JP 2006-146008 describes a “voice recognition means 5 configured to individually compare a plurality of words included in voice input from a voice input means with a plurality words stored in advance in a dictionary means, and recognize words having the highest competitive probability among competitive candidates. A word correction means 9 includes a word correcting function for correcting the plurality of words constituting a word string displayed on a screen” (Abstract).

### SUMMARY OF THE INVENTION

In a robot teaching device, the types of operating screens required for teaching a robot are diverse, and thus it is common for a selection menu to be hierarchized. Therefore, in order for an operator to transition to an intended operating screen through a key operation, not only are a plurality of key operations required, but also the operator needs to ascertain where the intended operating screen is located within the hierarchized selection menu.

According to an aspect of the present disclosure, a robot teaching device for teaching a robot includes a display device, a microphone configured to collect voice and output a voice signal, a voice recognition section configured to perform voice recognition processing on the voice signal and output character information representative of the voice, a correspondence storage configured to store information associating each of a plurality of types of operating screens with a recognition target word according to the teaching of the robot, a recognition target word extracting section configured to extract, from information stored in the correspondence storage, one or more of the recognition target words having a predetermined relevance to a word representative of the character information, and a screen list display unit configured to generate, on the basis of information stored in the correspondence storage, an image showing a list of one or more of the operating screens corresponding to one or more of the recognition target words thus extracted, and display the image on the display device.

### BRIEF DESCRIPTION OF THE DRAWINGS

The objects, features and advantages of the present invention will become more apparent from the following description of the embodiments in connection with the accompanying drawings, wherein:

FIG. 1 is a diagram illustrating an overall configuration of a robot system including a robot teaching device according to an embodiment;

FIG. 2 is a function block diagram of the robot teaching device;

FIG. 3 is a diagram illustrating a display example of a screen list displaying a list of operating screens;

FIG. 4 is a flowchart illustrating screen list display processing for displaying a list of operating screens having a predetermined relevance to a voice-inputted word by an operator;

FIG. 5 is a diagram illustrating a state in which an operating screen is selected by voice input;

FIG. 6 is a diagram illustrating a state in which a selection item on an operating screen is selected by voice input; and

FIG. 7 is a diagram illustrating an example of an editing screen of an operation program.

### DETAILED DESCRIPTION

Embodiments of the present disclosure will be described below with reference to the accompanying drawings. Throughout the drawings, corresponding components are denoted by common reference numerals. For ease of understanding, these drawings are scaled as appropriate. The embodiments illustrated in the drawings are examples for implementing the present invention, and the present invention is not limited to the embodiments illustrated in the drawings.

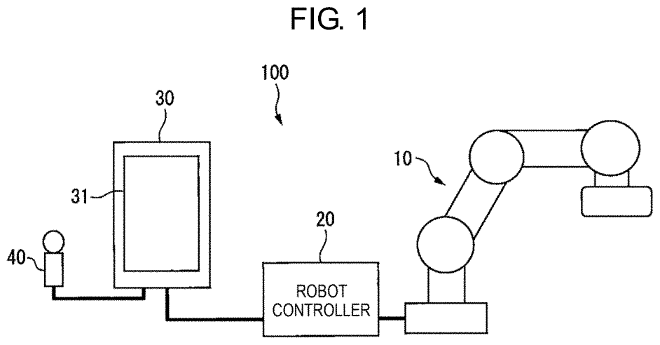

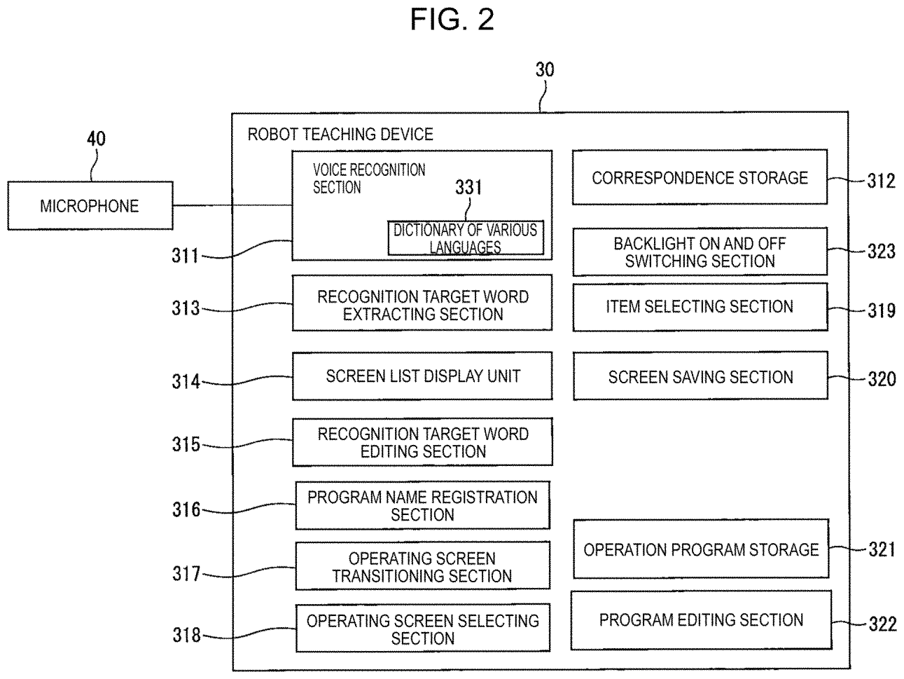

FIG. 1 is a diagram illustrating an overall configuration of a robot system 100 including a robot teaching device 30 according to an embodiment. FIG. 2 is a function block diagram of the robot teaching device 30. As illustrated in FIG. 1, the robot system 100 includes a robot 10, a robot controller 20 configured to control the robot 10, and the robot teaching device 30 connected to the robot controller 20. A microphone 40 configured to collect voice and output a voice signal is connected, by wire or wirelessly, to the robot teaching device 30. The microphone 40 may be incorporated into the robot teaching device 30. The microphone 40 may be configured as a headset type microphone worn by an operator operating the robot teaching device 30.

The robot 10 is, for example, a vertical articulated robot. As the robot 10, another type of robot may be used. The robot controller 20 controls an operation of the robot 10 in response to various commands input from the robot teaching device 30. The robot controller 20 may have a general computer configuration including a central processing unit (CPU), a read-only memory (ROM), a random access memory (RAM), a storage device, a display unit, an operating section, an external device interface, a network interface, and the like. The robot teaching device 30 is, for example, a portable information terminal such as a teach pendant or a tablet terminal. The robot teaching device 30 may have a general computer configuration including a CPU, a ROM, a RAM, a storage device, a display unit, an operating section, an external device interface, a network interface, and the like.

The robot teaching device 30 includes a display device 31. The display device 31 is, as an example, a flat panel display such as a liquid crystal display with a backlight. Further, the display device 31 includes a touch panel and, on a display screen of the display device 31, a soft key (not illustrated) arranged as an image is provided. The operator may operate an operation key (soft key) to teach or operate the robot 10. The soft key has a voice input switch for switching between acceptance and non-acceptance of voice input. Note that, when the robot teaching device 30 is configured as a teach pendant, the robot teaching device 30 includes a soft key and a hard key as operation keys.

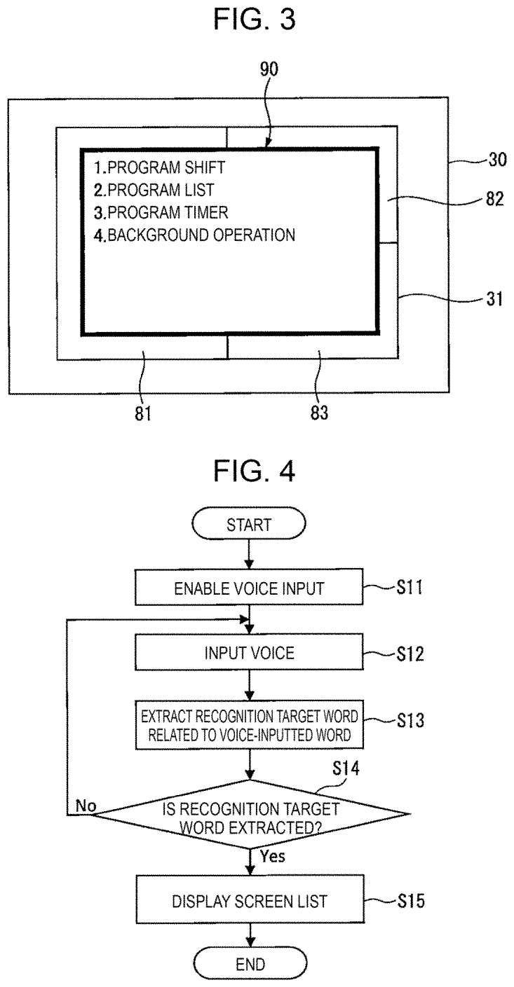

As illustrated in FIG. 2, the robot teaching device 30 includes a voice recognition section 311 configured to perform voice recognition processing on a voice signal input from the microphone 40 and output character information representative of the voice, a correspondence storage 312 configured to store information associating each of a plurality of types of operating screens relating to teaching of the robot 10 with a recognition target word, a recognition target word extracting section 313 configured to extract, from information stored in the correspondence storage 312, one or more of the recognition target words having a predetermined relevance to words representative of the voice-inputted character information, and a screen list display unit 314 configured to generate, on the basis of information stored in the correspondence storage 312, an image (refer to FIG. 3) showing a list of one or more operating screens corresponding to one or more recognition target words thus extracted, and display the image on the display device 31.

The correspondence storage 312 may be configured to store names (or an ID) of operating screens in association with recognition target words as information indicating a correspondence between the operating screen and the recognition target word. Table 1 below shows an example of information stored in the correspondence storage 312. In Table 1, the recognition target word “program shift” is associated with the operating screen “Program Shift”, the recognition target word “program list” is associated with the operating screen “Program List”, the recognition target word “program timer” is associated with the operating screen “Program Timer”, the recognition target word “background operation” is associated with the operating screen “Background Operation”, the recognition target word “tool coordinate system settings” is associated with the operating screen “Tool Coordinate System Settings”, and the recognition target word “operation mode settings” is associated with the operating screen “Operation Mode Settings”. Note that a plurality of recognition target words may be associated with a name of one operating screen.

TABLE 1

| Operating Screen | Recognition Target Word |
|---|---|
| Program Shift | “program shift” |
| Program List | “program list” |
| Program Timer | “program timer” |
| Background Operation | “background operation” |
| Tool Coordinate System Settings | “tool coordinate system settings” |

The operating screens exemplified in Table 1 are screens for processing such as the following.
Program Shift: An operating screen related to processing for modifying (shifting) a teaching point position of an operation program of the robot.
Program List: An operating screen for displaying a list of operation programs registered in the robot teaching device, and selecting an operation program.
Program Timer: An operating screen related to an execution time of the operation program.
Background Operation: An operating screen for specifying a process which executes an operation in the background of the operation program.
Tool Coordinate System Settings: An operating screen for setting a tool coordinate system of the robot.
Operation Mode Settings: An operating screen for setting an operating mode of the robot.

FIG. 4 is a flowchart illustrating a screen list display process for displaying a list of operating screens having predetermined relevance to voice-inputted words by an operator. The screen list display process is executed under the control of the CPU of the robot teaching device 30. Initially, the operator operates the voice input switch to enable voice input (step S11). Next, the operator inputs the voice (step S12). Here, it is assumed that the information shown in Table 1 is stored in the correspondence storage 312, and that the operator, intending to operate the operating screen related to the operation program, utters “program”, for example. The voice recognition section 311 includes dictionary data 331 required for voice recognition, such as an acoustic model, a language model, and the like for a plurality of types of languages, and performs, by using the dictionary data 331, voice recognition processing on input voice signals. In the present example, the voice recognition section 311 outputs “program” as character information.

Next, the recognition target word extracting section 313 extracts the recognition target word having a predetermined relevance to the voice-inputted word from the correspondence storage 312 (step S13). Determination criteria for determining the presence or absence of a predetermined relevance include, for example, one or more of the determination criteria (r1) to (r3) below.

(r1) The recognition target word includes the voice-inputted word.

(r2) The recognition target word and the voice-inputted word have the same meaning.

(r3) An operating screen corresponding to the recognition target word includes contents corresponding to the voice-inputted word.

In step S14, it is determined whether or not a recognition target word relevant to the voice-inputted word has been extracted on the basis of the above-described determination criteria (r1) to (r3), for example. When, as a result, a recognition target word having a predetermined relevance to the voice-inputted word is extracted (S14: Yes), the robot teaching device 30 (screen list display unit 314) displays on the display device 31 a list of operating screens associated with the extracted recognition target word in the correspondence storage 312 (step S15). When a recognition target word is not extracted (S14: No), the process returns to step S12.

FIG. 3 illustrates, by way of example, a screen list 90 of the operating screens extracted from the information shown in Table 1 on the basis of the above-described determination criteria (r1) to (r3) when the operator utters “program”. Among the operating screens displayed in the screen list 90, “1. Program Shift”, “2. Program List”, and “3. Program Timer” are selected, on the basis of the above-described determination criterion (r1), as recognition target words including the uttered word “program”. “4. Background Operation” in the screen list 90 is an operating screen related to operation processing operated in the background of the operation program, and is selected, on the basis of the above-described determination criterion (r3), as an operating screen including contents corresponding to the uttered word “program”.

As illustrated in FIG. 3, the screen list 90 may be displayed as a pop-up style image in the center on the display screen of the display device 31. In the example of FIG. 3, the screen list 90 is displayed in a style in which the screen list 90 is overlaid on windows 81 to 83 displayed on the display screen. The robot teaching device 30 accepts selection by key operation or voice input for selecting a desired operating screen from the screen list 90, and executes screen transitions to the selected operating screen.

According to the screen list display process of the present embodiment described above, the operator can display on the display screen a list of operating screens relevant to an uttered word, allowing the operator to easily transition to a desired operating screen even when the operator does not remember the name of the operating screen correctly.

When a recognition target word whose difference from a voice-inputted word satisfies predetermined determination criterion is detected, the recognition target word extracting section 313 may add the voice-inputted word to the correspondence storage 312 as a new recognition target word corresponding to the operating screen associated with the recognition target word thus detected in the correspondence storage 312. The predetermined determination criteria are, for example, criteria such as the following.

(h1) A difference in characters between the uttered word and the recognition target word is within a predetermined number of characters.

(h2) The uttered word and the recognition target word have the same meaning.

For example, assume that the operator utters “shift program” with the intention of calling up the operating screen “Program Shift”. In this case, the recognition target word extracting section 313 stores “shift program” as a new recognition target word in association with the operating screen “Program Shift” in the correspondence storage 312. According to this configuration, even when the operator utters words that are somewhat different from a recognition target word or even when a slight recognition error occurs in the voice recognition processing, these are added as recognition target words, thereby making it possible to subsequently use such recognition target words to generate a screen list by the screen list display unit 314.

As illustrated in the function block diagram of FIG. 2, the robot teaching device 30 further includes a recognition target word editing section 315, a program name registration section 316, an operating screen transitioning section 317, an operating screen selecting section 318, an item selecting section 319, a screen saving section 320, an operation program storage 321, a program editing section 322, and a backlight on and off switching section 323.

The recognition target word editing section 315 provides functions for editing, such as adding, changing, and deleting, information stored in the correspondence storage 312. With these functions, the operator can store, in association with the operating screens, recognition target words that are personally more convenient. Note that the recognition target word editing section 315 may be configured to accept a recognition target word to be newly registered in the correspondence storage 312 through voice input.

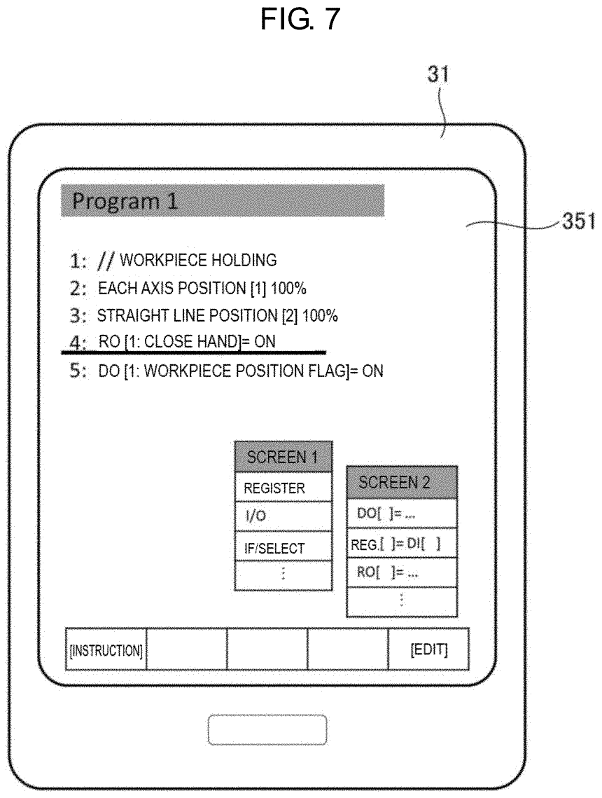

The program editing section 322 provides functions for creating and editing an operation program. The operation program storage 321 stores, for example, an operation program created by the program editing section 322. FIG. 7 illustrates, by way of example, an editing screen 351 of an operation program displayed on the display device 31 by the program editing section 322. An operator OP, upon selecting the fourth row on the editing screen 351 by a key operation, can operate the voice input switch to enable voice input, and input the comment “Close hand” related to the statement “RO [1]” by voice input, for example. “Workpiece holding” in the first row and “Workpiece holding flag” in the fifth row of the editing screen 351 are examples of comments input by voice input.

The program name registration section 316 stores a program name of the operation program newly created by the program editing section 322, as a new recognition target word in the correspondence storage 312, in association with an operating screen related to execution or editing of the operation program of the robot 10. For example, when an operator creates a new operation program named “Handling”, the recognition target word “Handling” is stored in association with the editing screen of the operation program “Handling” in the correspondence storage 312. In this case, the operator can easily call up the editing screen of the operation program “Handling” by uttering “Handling”.

The operating screen transitioning section 317 stores the history of transitions of the operating screens resulting from operations by the operator. Then, the operating screen transitioning section 317 provides a function that, in response to a predetermined target word (hereinafter, referred to as a first target word) being included in voice-inputted words, returns the operating screen currently displayed on the display device 31 to the operating screen displayed immediately prior to the operating screen currently displayed. The first target word is, for example, “Return”, “Back”, or the like.

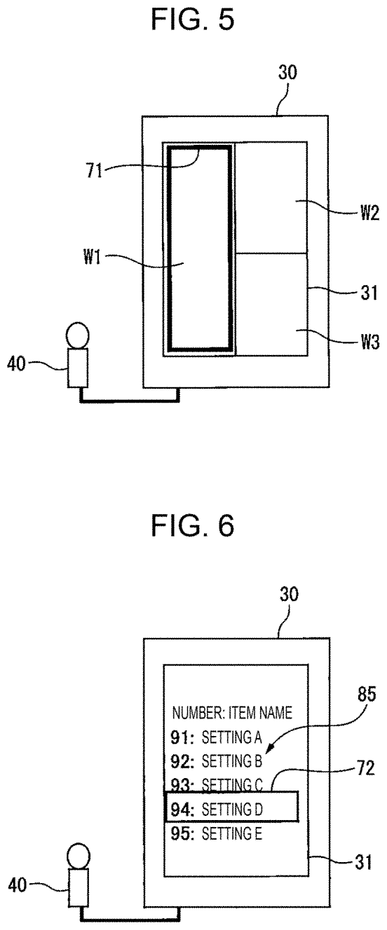

The operating screen selecting section 318 provides a function for selecting, on the basis of the voice-inputted words, an operating screen to be operated from among two or more operating screens displayed on the display device 31. Specifically, the operating screen selecting section 318 is configured to, in response to voice-inputted words that include a predetermined target word (e.g., “Left”, “Upper right”) indicating a position of the operating screen, select, from the displayed operating screens, one operating screen corresponding to the designation by the operator. For example, assume that, as illustrated in FIG. 5, three windows (operating screens) W1, W2, and W3 are displayed on the display screen of the display device 31. When the operator utters “Left”, for example, with the intention to select the window W1, the window W1 is selected as the operation target and a perimeter of the window W1 is highlighted by a thick line 71.

The item selecting section 319 provides a function for selecting, when a plurality of selection items are included on the operating screen currently being operated, one of the selection items on the basis of character information representative of the voice. For example, as illustrated in FIG. 6, when the operator utters a word, in a state where a menu 85 including a plurality of setting items is displayed on an operating screen related to function settings, the item selecting section 319 selects an item corresponding to the uttered word. FIG. 6 illustrates a state in which, as a result of the operator uttering “Setting D” or “94”, for example, the item “94: Setting D” is selected and this item “94: Setting D” is highlighted by a thick frame 72.

The backlight on and off switching section 323 provides a function for turning on and off the backlight of the display device 31 on the basis of a voice-inputted word. For example, in a state in which the backlight is on, the backlight on and off switching section 323 turns off the backlight in response to a predetermined target word “Turn off backlight” serving as voice input for instructing the backlight to be turned off. Further, in a state in which the backlight is off, the backlight on and off switching section 323 turns on the backlight in response to a predetermined target word “Turn on backlight” serving as voice input for instructing the backlight to be turned on.

The screen saving section 320 provides a function for saving information of the operating screen currently displayed on the display device 31 when a predetermined target word (hereinafter, referred to as a second target word) for saving a screen is included in voice-inputted words. The screen saving section 320 may be configured to save an image of an operating screen. The second target word is, for example, “Save screen” having a meaning of saving screen.

The above-described target words and words serving as commands for causing the operating screen transitioning section 317, the operating screen selecting section 318, the item selecting section 319, the backlight on and off switching section 323, and the screen saving section 320 to execute functions are stored in advance in a storage device of the robot teaching device 30. The operating screen transitioning section 317, the operating screen selecting section 318, the item selecting section 319, the backlight on and off switching section 323, and the screen saving section 320 may be configured to execute operations when the above-described predetermined target words and words stored in the robot teaching device 30 are included in the words recognized by the voice recognition section 311.

Although the foregoing has described the invention using a representative embodiment, it will be clear to one skilled in the art that many variations on the embodiment, as well as other modifications, omissions, and additions, can be made without departing from the scope of the invention.

The program for executing the screen list display processing (FIG. 4) illustrated in the embodiments described above can be stored on various recording media (e.g., a semiconductor memory such as a ROM, an EEPROM, and a flash memory, a magnetic recording medium, and an optical disk such as a CD-ROM and a DVD-ROM) readable by a computer.

1. A robot teaching device for teaching a robot, comprising:
a display device;
a microphone configured to collect voice and output a voice signal;
a voice recognition section configured to perform voice recognition processing on the voice signal and output character information representative of the voice;
a correspondence storage configured to store information associating each of a plurality of types of operating screens with a recognition target word relating to teaching of the robot;
a recognition target word extracting section configured to extract, from the information stored in the correspondence storage, one or more recognition target words having a predetermined relevance to a word representative of the character information; and
a screen list display unit configured to generate, on the basis of the information stored in the correspondence storage, an image showing a list of one or more operating screens corresponding to one or more recognition target words thus extracted, and display the image on the display device.

2. The robot teaching device according to claim 1, further comprising:
a recognition target word editing section configured to edit the information stored in the correspondence storage.

3. The robot teaching device according to claim 1, further comprising:
a program editing section configured to create and edit an operation program of the robot; and
a program name registration section configured to store a program name of the operation program created by the program editing section in association with an operating screen related to execution or editing of the operation program as a new recognition target word in the correspondence storage.

4. The robot teaching device according to claim 1, wherein
when the recognition target word whose difference from a word representative of the character information satisfies predetermined determination criterion is detected, the recognition target word extracting section is configured to add the word representative of the character information to the correspondence storage as a new recognition target word corresponding to the operating screen associated with the recognition target word thus detected in the correspondence storage.

5. The robot teaching device according to claim 1, further comprising:
an operating screen transitioning section configured to save a history of transitions of the plurality of types of operating screens and, in response to a first target word being included in the character information representative of the voice, return the operating screen currently displayed on the display device to the operating screen displayed immediately prior to the operating screen currently displayed, on the basis of the history.

6. The robot teaching device according to claim 1, further comprising:
an operating screen selecting section configured to select, on the basis of the character information representative of the voice, an operating screen to be operated from among two or more operating screens displayed on the display device.

7. The robot teaching device according to claim 1,
wherein the display device includes a backlight,
the robot teaching device further comprising:
a backlight on and off switching section configured to switch on and off of the backlight on the basis of the character information representative of the voice.

8. The robot teaching device according to claim 1, further comprising:
an item selecting section configured to select, when a plurality of selection items are included in the operating screen displayed on the display device, one of the plurality of selection items on the basis of the character information representative of the voice.

9. The robot teaching device according to claim 1, further comprising:
a screen saving section configured to save information of the operating screen currently displayed on the display device when a second target word for saving a screen is included in the character information representative of the voice.
